(19) United States
(12) Patent Application Publication
(10) Pub. No.: US 2011/0222978 A1
(43) Pub. Date: Sep. 15, 2011

(54) ADVANCEMENT GUIDE UNIT FOR ENSURING THE STRAIGHT-LINE MOTION OF A MANUALLY GUIDED MACHINE TOOL

(75) Inventors: Jens Mario LANGE, Albstadt (DE); Günther HARTMANN, Albstadt (DE); Ingo V. PUTTKAMER, Messtetten (DE)

(73) Assignee: GUEHRING OHG, Albstadt (DE)

(21) Appl. No.: 13/039,836

(22) Filed: Mar. 3, 2011

Related U.S. Application Data
(63) Continuation of application No. PCT/DE2009/001239, filed on Sep. 4, 2009.

(30) Foreign Application Priority Data
Sep. 8, 2008 (DE) 10 2008 046 283.7
Mar. 6, 2009 (DE) 10 2008 003 579.6

(51) Int. Cl. B23B 45/14

(52) U.S. Cl. 408/115 R

(57) ABSTRACT

The invention relates to an advancement guide unit (5) for ensuring the straight-line motion of a manually guided machine tool (I), particularly a portable drill, in the direction of advancement thereof and is substantially composed of a support element (12) for support on a work-piece to be treated and a carriage (30) guided displaceably on the support element (12) relative thereto in the direction of advancement for supporting and guiding the machine tool (1). According to the Invention, a damper (33) acting 48 in the direction of advancement is disposed between the support element (12) and the carriage (30), said damper damping the initial stroke of the carriage (30) toward the support element (12) over a predefined initial stroke distance (y). In a refinement, the damper (33) is disposed between the support element (12) and carriage (30) such that the damping of the initial stroke of the carriage (30) only commences after a primary, undamped initial stroke of the carriage (30).

### CROSS-REFERENCE TO RELATED APPLICATIONS

This application is a continuation of International Application No. PCT/DE2009/001239, having an international filing date of Sep. 4, 2009, the entirety of which is incorporated herein by reference as if set forth in its entirety.

This application claims the benefit of German Patent Application No. 10 2008 046 283.7, filed Sep. 8, 2008, the entirety of which is incorporated herein by reference as if set forth in its entirety.

This application claims the benefit of German Patent Application No. 10 2008 003 579.6, filed Mar. 6, 2009, the entirety of which is incorporated herein by reference as if set forth in its entirety.

The invention relates to an advancement guide unit for ensuring the straight-line motion of a manually guided machine tool, in particular of a portable drill, in the direction of advancement thereof.

### BACKGROUND ART

Advancement guide units of this kind have the function of guiding a tool rotationally driven by a manually guided machine tool, e.g., a portable drill or portable surface milling cutter, toward or away from a workpiece being processed in a straight line, in most cases perpendicularly. Examples of the like advancement guide units are found in DE 10355351 A1 or DE 602004007591 T2. DE 10355351 A1 describes an advancement guide unit wherein a portable drill is forcibly moved in a straight line in dependence on the rotational speed thereof, i.e., the advancement of the portable drill takes place in a manner dependent on the rotational speed. DE 602004007591 T2 describes a guide unit for a surface milling cutter wherein the advancement of the surface milling cutter is dependent on the force applied by the user.

When a workpiece is processed by means of a manually guided machine tool while the advancement is controlled by the user, advancement speed and advancement force vary from case to case in a greater or lesser degree. When a through hole is produced in a workpiece, the axial force required for advancement diminishes to zero within an extremely short time span immediately before or at the moment at which the processing tool exits from the workpiece. If the user is unable to quickly enough reduce the axial force applied by him within this very short time span, the processing tool will pierce through the workpiece, possibly at a high advancement speed and advancement force. Particularly in the processing of fiber-reinforced materials, for example carbon fiber reinforced plastic (CFRP) materials, e.g. in the production of rivet hole bores, a processing tool driven with a high advancement force piercing through the workpiece would result in fibers being torn from the fiber compound. As a result the required dimensional accuracy may not be ensured, or in a given case the workpiece will require post-processing. At any rate, disadvantageous effects with regard to processing quality and manufacturing costs would ensue.

### PROBLEM TO BE SOLVED

Starting out from this situation, the invention is based on the object of providing an advancement guide unit for ensuring the straight-line motion of a manually guided machine tool, in particular a portable drill, e.g. a pneumatic portable drill, in the direction of advancement thereof, wherein uncontrolled penetration of the processing tool through a workpiece being processed is largely precluded.

### SOLUTION

This object is achieved through an advancement guide unit having the features of claim 1. Advantageous and expedient developments are subject matter of appended claims.

A generic advancement guide unit for ensuring the straight-line motion of a manually guided machine tool, preferably a portable drill, in the direction of advancement thereof comprises a support element to be supported on a workpiece being processed, as well as a carriage displaceably guided on the support element relative to the latter in the direction of advancement for supporting and guiding the machine tool. In accordance with the invention, a damper acting in the direction of advancement is disposed between the support element to be supported on the workpiece, i.e., the stationary portion of the advancement guide unit, and the carriage movable relative to the support element, i.e., the movable portion of the advancement guide unit which supports the machine tool and guides the processing tool driven thereby, said damper dampening the initial stroke of the carriage toward the support element over a predetermined initial stroke distance.

The advancement guide unit of the invention guarantees on the one hand the required straight-line guidance, for instance perpendicularly to the workpiece being processed, of the manually guided machine tool and thus of the processing tool driven by it. On the other hand, the damper disposed between support element and carriage allows to obtain dampening of the initial stroke of the carriage relative to the support element and thus dampening of the advancement of the machine tool and of the processing tool driven by it over an adjustable initial stroke distance. With the aid of the advancement guide unit of the invention, the user is capable of controlling advancement force and advancement speed in the customary manner during processing of the workpiece, for instance when drilling a CFRP material. As a sole difference, the tool advancement is dampened by the damper via the initial stroke distance set by the user, which will expediently be immediately prior to the exit of the processing tool from the workpiece being processed in the case of through holes.

The damper is expediently disposed between the support element and the carriage such that it will take effect only after an initial stroke of the carriage from a starting position at which the carriage has a maximum distance from the support element, and such that the adjustable initial stroke distance subsequent to the first initial stroke of the carriage extends as far as to reach an end position at which the carriage has a minimum distance from the support element. In this way the maximum possible initial stroke of the carriage is subdivided into an initially undampened initial stroke and a subsequent, dampened initial stroke. When producing a through bore in a workpiece, for example, this development allows the tool advancement controlled by the user to be subjected to dampening only shortly before the drilling tool exits from the workpiece being processed. Such advancement dampening moreover allows the user to take note that the drilling tool is about to exit from the workpiece. In addition to the advancement dampening obtained through the advancement guide unit of the invention, the user thus informed may then reduce the further tool advancement according to conditions.

In order to be able to keep the manufacturing costs low, the damper is preferably realized of a conventional piston that is guided on a piston rod inside a cylinder filled with oil or gas.

For an adaptation, e.g., to different tool material thicknesses, the damper preferably is arranged on the carriage in an axially adjustable manner. As a result, the length of the undampened initial stroke of the carriage, or the position in the direction of advancement at which the dampened initial stroke of the carriage begins, may be adjusted in accordance with the respective conditions.

The support element is expediently realized such that it may be applied against the workpiece being processed in the manner of a tripod having legs that are adjustable in length. This development allows the advancement guide unit of the invention to be applied not only to planar, plate-shaped workpieces but also to workpieces having curved surfaces, such as pipes. As a result of the length-adjustable legs it is possible to achieve, for example, a perpendicular tool advancement independently of whether the workpiece surface to be processed is planar or curved.

In order to ensure reliable guidance of the carriage relative to the support element, a multiplicity of guide elements guiding the carriage in the direction of advancement are preferably arranged on the support element, i.e., on the stationary portion of the advancement guide unit. The multiplicity of guide elements allow to ensure that jamming of the carriage relative to the support element is avoided in a maximum degree.

The multiplicity of guide elements preferably include a guide casing provided on the support element and peripherally encompassing the carriage in the manner of a sleeve. Besides the function of guiding the carriage, this development provides the advantage that during processing of a workpiece, the user may grasp the guide casing as a component part of the support element of the support element which is stationarily applied against the workpiece being processed. In this development the user may apply the advancement guide unit of the invention against the workpiece being processed, and may further position and grasp it with the aid of the support element representing the stationary portion. As the carriage representing the movable portion of the advancement guide unit of the invention is displaceably received in the guide casing and thus guided externally, the initial stroke of the carriage and accordingly the advancement of the machine tool and of the processing tool are not hampered, other than in a case where the carriage is guided exclusively by guide elements slidingly arranged in the carriage.

As an alternative, but preferentially in addition to the guide casing encompassing the carriage in the manner of a sleeve, the multiplicity of guide elements include one or several guide columns disposed on the support element and each received in an associated guide cylinder that is formed in the carriage. In this development the guide columns are preferably situated on a same diameter relative to a longitudinal center axis of the advancement guide unit of the invention. Ideally, the guide columns are disposed in pairs and diametrically relative to the longitudinal center axis of the advancement guide unit.

As an alternative, but preferentially in addition to the guide casing described in the foregoing and the guide columns described in the foregoing, the multiplicity of guide elements include a piston guide means disposed coaxially with a longitudinal center axis of the advancement guide unit, which piston guide means is realized of a piston on a piston rod arranged in the support element, and is received in a guide cylinder formed in the carriage. The central arrangement of the piston guide means was in particular found to be expedient in the above-described development where the support element may be applied against the workpiece in the manner of a tripod.

The processing tool rotationally driven by the machine tool is suitably received in a guide sleeve which is disposed, preferably in a replaceable manner, on the carriage. The guide sleeve ensures that the longitudinal axis of the processing tool will always keep an orientation in parallel with the direction of advancement. In the preferred area of application of the advancement guide unit of the invention, i.e., in the case of a portable drill, such replaceability allows the use of a respective appropriate guide sleeve for different drilling tool diameters. For an adaptation of the advancement guide unit of the invention to different drilling tool lengths, the guide sleeve moreover is preferably disposed on the carriage so as to be displaceable in an axial direction, i.e., in parallel with the direction of advancement.

It is furthermore an advantage if the damper and the guide sleeve have a diametrical arrangement relative to a longitudinal center axis of the advancement guide unit. This arrangement reliably prevents “tilting” of the carriage relative to the support element.

The guide sleeve receiving the processing tool and guiding it in the direction of advancement of the machine tool may be arranged on the carriage non-rotatably relative to the latter, or may be mounted rotatably relative to the latter. A non-rotatable arrangement of the guide sleeve on the carriage can be realized with comparative ease in terms of construction. In the case of a non-rotatable arrangement, the internal diameter of the guide sleeve is configured such that the guide sleeve receives the processing tool in the manner of a running fit, i.e., with lateral play. Mounting of the guide sleeve for a rotational movement relative to the carriage may be realized through the intermediary of a sliding mount of the guide sleeve in a corresponding reception bore in the carriage or, on the other hand, by interposing a suitable antifriction bearing (ball bearing or roller bearing). In comparison with a non-rotatable arrangement, rotatable mounting of the guide sleeve provides the advantage of the guide sleeve being allowed to rotate jointly with the processing tool when the latter is driven rotationally. The internal diameter of the rotatably mounted guide sleeve may therefore be designed with narrower tolerances as compared with the non-rotatable arrangement, resulting in more accurate guidance of the processing tool. As the processing tool ceases to have a chip discharge or chip conveying effect relative to the guide sleeve if the guide sleeve rotates jointly with the rotationally driven processing tool, jamming of the processing tool due to chips being backed up in the guide sleeve or—for example in a case where a CFRP material is processed—chips being compacted in the guide sleeve may be prevented in difference from the case where the processing tool rotates relative to the guide sleeve.

If processing of the workpiece is to consist, e.g., in the production of a blind bore having a limited depth or in the production of a counterbore for receiving a rivet head, the advancement guide unit of the invention may moreover comprise an adjustable limit stop for limiting the maximum initial stroke of the carriage relative to the support element. This limit stop may be provided on the support element or on the carriage and may, for example, be realized as a screw limit stop screwed in on the support element or carriage in a direction parallel with the direction of advancement, the head of which enters into contact with the carriage or the support element, respectively, once the maximum initial stroke of the carriage has been reached. In a preferred manner, the adjustable limit stop is executed such as to ensure extremely fine adjustability of depth in the range of one-tenth of a micrometer. Such is necessary, for instance, in order to produce a rivet hole bore in materials for aircraft, where it is crucial that a rivet head placed in the rivet hole bore is as flush as possible with the external surface of the material being processed.

In a suitable manner, a biasing means exerting a return stroke force on the carriage and preferably realized as a compression spring may moreover be disposed between the support element and the carriage.

### DRAWINGS

The drawings schematically represent a preferred practical example of a guide unit of the invention, wherein:

FIG. 1 shows a longitudinal sectional view of the preferred practical example along a plane A-A indicated in FIG. 3,

FIG. 2 shows a longitudinal sectional view of the preferred practical example along a plane B-B indicated in FIG. 3, and

FIG. 3 shows a cross-sectional view of the preferred practical example along a plane C-C indicated in FIGS. 1 and 2.

### DESCRIPTION OF A PREFERRED PRACTICAL EXAMPLE

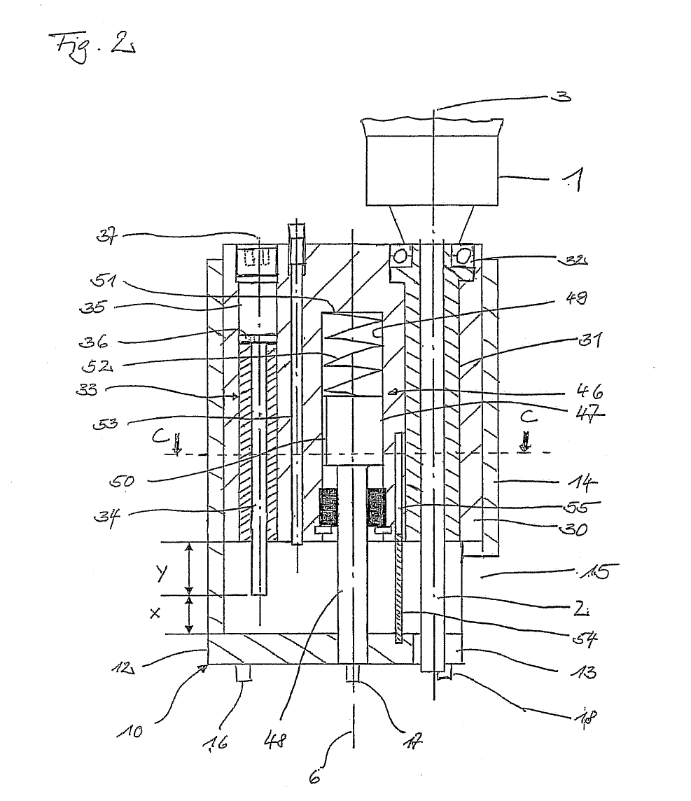

The advancement guide unit 5 of the invention as represented in the figures is adapted for guiding a pneumatic portable drill 1 schematically represented in FIG. 2 and essentially includes a support element 10 to be applied against a workpiece to be drilled (not represented), as well as a carriage 30 retained on the support element 10 so as to be displaceable relative to the latter, said carriage guiding the portable drill 1 together with a drilling tool 2 clamped therein in the direction of advancement along the rotation axis 3 of the portable drill 1 for the purpose of drilling processing of the workpiece. The rotation axis 3 of the portable drill 2 is parallel with a longitudinal center axis 6 of the advancement guide unit 5.

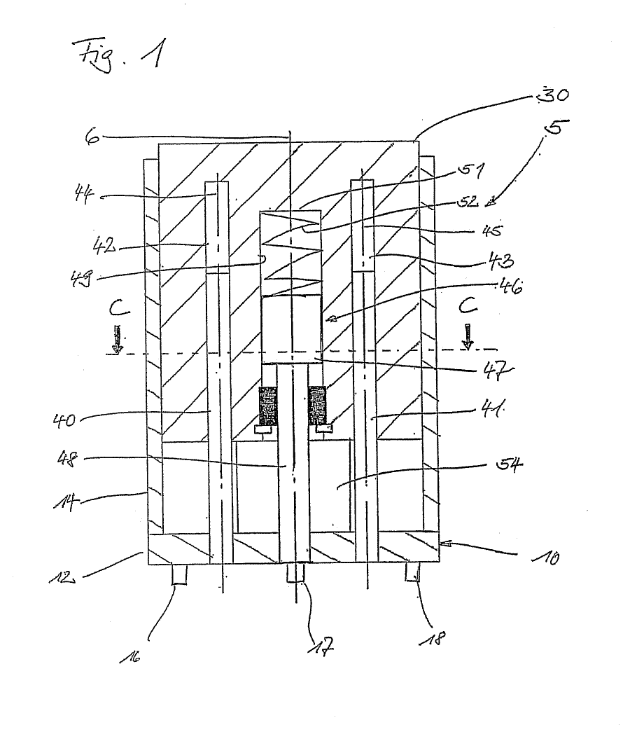

The support element 10 is formed by a circular support plate 12, a cylindrical guide casing 14 arranged at the upper side of the support plate 12, as well as supporting legs 16, 17, 18 arranged at the lower side of the support plate 12 and represented schematically in FIGS. 1 and 2.

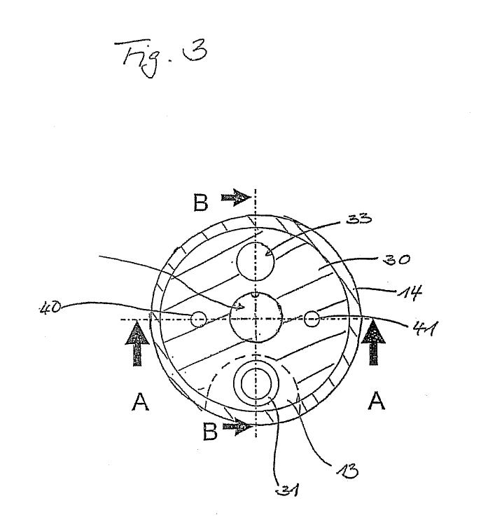

As may be seen in FIGS. 2 and 3, the support plate 12 has a circumferentially open recess 13 in which the drilling tool 2 driven by the portable drill 1 runs. Around the recess 13, a wall 54 which is received in a corresponding guide opening 55 formed on the carriage 30 is furthermore arranged at the support plate 12 in a retractable manner. The wall 54, in combination with the guide casing 14 which will be explained further below, has the function of screening the space between the support element 12 and the carriage 30 as far as possible against the external environment in order to prevent pollutions, in particular drilling chips, from entering between the support element 12 and the carriage 30, whereby the functionality of the advancement guide unit 5 might be placed at risk.

The guide casing 14 may be formed integrally with the support plate 12 or may, in accordance with the representation in FIGS. 1 and 2, be fixedly connected to the support plate 12 in a suitable way, e.g. by screw connection. The guide casing 14 encompasses the carriage 30 in the manner of a guide sleeve. On the outer peripheral side the guide casing 14 may be finished in a manner appropriate, for instance roughened, so as to enhance grip. In the area of the recess 13 the guide casing 14 includes—as is represented in FIG. 2—a window 15 allowing the user to view the drilling tool 2 as well as the area of the workpiece in which drilling is to be carried out.

The supporting legs 16, 17, 18 are appropriately fastened to the lower side of the support plate 12 at regular angular intervals in the manner of a camera stand or tripod, e.g., by screw connection, and adapted to be adjustable in length. Thanks to the adjustable length of the supporting legs 16, 17, 18 the support element 10 may be applied in a stable manner and in the respective desired orientation against workpieces having any desired shape.

In order to keep the weight of the advancement guide unit 5 as low as possible, the support element 10 is preferably made entirely of anodized aluminum.

The carriage 30 received in the guide casing 14 is made of a cylindrical block, preferably of anodized aluminum. The carriage 30 has the function of supporting the portable drill 1 in the direction of advancement of the drilling tool 2 and guiding the drilling tool 2 rotationally driven by the portable drill 1. To this end, a guide sleeve 31 represented in FIG. 2 is replaceably inserted in the carriage 30. The internal diameter of the inserted guide sleeve 31 is adapted to the external diameter of the respective drilling tool 2 to be guided. In the shown practical example, the guide sleeve 31 is inserted non-rotatably in the carriage 30. The internal diameter of the guide sleeve 31 is adapted such that the guide sleeve 31 receives the processing tool 2 in the manner of a running fit, i.e., with lateral play. On the side of the end of the guide sleeve 31 facing the portable drill 5, a mount 32 in the form of a thrust bearing is arranged next to the guide sleeve 31 and coaxially with the latter.

A damper 33 is arranged in the carriage 30, diametrically opposite the guide sleeve 31 in relation to the longitudinal center axis 6 of the advancement guide unit 5. The damper 33 consists of a piston 36 guided on a piston rod 34 inside a cylinder 35 that is filled with oil or gas. The longitudinal axis 37 of the damper 33 extends in parallel with the longitudinal center axis 6 of the advancement guide unit 5 or with the rotation axis of the portable drill 1, respectively. The damper 33 has the function of dampening the initial stroke of the carriage 30, from the starting position shown in FIGS. 1 and 2 at which the carriage 30 has a maximum distance from the support element 10 toward the support element 10, to thereby dampen the advancement of the drilling tool 2 driven by the portable drill 1 over a predetermined initial stroke distance y. To this end, the damper 33 is arranged between the support element 10 and the carriage 30 such that starting out from the starting position shown in FIGS. 1 and 2 it will take effect only after a predetermined initial stroke distance x has been covered along which the initial stroke of the carriage 30 is not dampened. The predetermined initial stroke distance y along which the initial stroke of the carriage 30 is dampened extends as far as an end position at which the carriage 30 has a minimum distance from the support element 10. The damper 33 is arranged in the carriage 30, along the longitudinal axis 37 thereof, in a longitudinally adjustable manner. This provides the user with the possibility of adjusting the lengths of the initial stroke distances x and y, or the position in the direction of advancement at which the damper 33 begins to take effect, in accordance with the respective processing conditions.

In accordance with the schematic representation in FIG. 2, the carriage 30 moreover carries a limit stop 53 arranged in a longitudinally adjustable manner which limits the maximum possible initial stroke of the carriage 30 and thus defines the end position of the carriage 30 in the direction of advancement.

In order to ensure a reliable guidance of the carriage 30 relative to the support element 10 between the starting and end positions, i.e., in order to prevent jamming of the carriage 30 relative to the support element 10, the advancement guide unit 5 includes in addition to the guide casing 14 further guide elements that are disposed between the support element 10 and the carriage 30. Among these further guide elements there are a pair of guide columns 40, 41 arranged diametrically relative to the longitudinal center axis 6 of the advancement guide unit 5 and a centrally arranged piston guide means 46. The guide columns 40, 41 are fastened to the support plate 12 of the support element 10 in an appropriate manner, e.g. by screw connection, and each displaceably received in an associated cylinder bore 42, 43 formed in the carriage 30. The guide columns 40, 41 are situated approximately on a same diameter relative to the longitudinal center axis 6 of the advancement guide unit 5. The plane of longitudinal sectional view containing the axes 44, 45 of the two guide columns 40, 41 is rotated through 90 degrees relative to the plane of longitudinal sectional view containing the axes 37, 3 of the damper 33 and of the guide sleeve 31. The piston guide means 46 consists of a piston 47 on a piston rod 48 appropriately fastened to a support plate 12 of the support element 10, with the piston being displaceably received in a cylinder bore 49 formed in the carriage 30. The piston rod 48 moreover runs inside a plastic bush 50 closing the cylinder bore 49 on the lower side in the representation of FIGS. 1 and 2. In order to enable effective pressure compensation between the space of the cylinder bore 49 situated above the piston 47 in the representation of FIGS. 1 and 2 and the space of the cylinder bore 49 situated between the plastic bush 50 and the piston 47, a longitudinal groove 50 is formed on the outer circumference of the piston 47.

Between the piston 47 and the bottom 51 of the cylinder bore 49 a compression spring 52 is inserted which applies a force acting in the return stroke direction to the carriage 30.

The longitudinal axes of the guide columns 40, 41 of the guide piston 46 are parallel with the longitudinal center axis 6 of the advancement guide unit 5 and thus also parallel with the direction of advancement of the drilling tool 2.

Thanks to the guide casing 14 encompassing the carriage 30 in the manner of a sleeve, the guide columns 40, 41, and the central piston guide means, the advancement guide unit 5 having this construction ensures the required straight-line guidance of the portable drill 1 and thus of the drilling tool 2 driven by the latter in the direction of advancement thereof. On the other hand, dampening of the initial stroke of the carriage 30 relative to the support element 30 and thus dampening of the advancement of the portable drill 1 and of the drilling tool 2 driven by the latter over a predetermined initial stroke distance y is obtained through the damper 33 disposed between the support element 10 and the carriage 30. The predetermined initial stroke distance y begins only after a first initial stroke distance x of the carriage 30 has been covered. The initial stroke distances x and y may be adjusted by a longitudinal adjustment of the damper 33 along its longitudinal axis 37. As a result of this disposition, the advancement guide unit of the invention 5 allows to subdivide the maximum possible initial stroke of the carriage 30 into a first, undampened initial stroke over the initial stroke distance x and, subsequently to the latter, a dampened initial stroke over the initial stroke distance y.

In a modification of the practical example described in the foregoing, the functions of the damper 33 and of the central piston guide means 46 may be combined in a centrally arranged damper/guide element. Furthermore the adjustable limit stop 53 may suitably be arranged not on the carriage 30 but on the support element 12. Likewise, the damper 33 and the central piston guide means 46 may be arranged not on the carriage 30 and the support plate 12 but on the support plate 12 and on the carriage 30, respectively. Instead of or in addition to the compression spring 33 disposed between the piston 47 and the carriage 30, further compression springs may be arranged around the guide columns 40, 41.

In a further modification of the practical example described in the foregoing, the guide sleeve 31 is mounted rotatably, instead of non-rotatably, in the carriage 30. For instance, the guide sleeve 31 is inserted in the carriage in the manner of a slide bearing or, on the other hand, mounted in the carriage so as to be rotatable relative to the latter by interposing a suitable antifriction bearing (ball bearing or roller bearing). In comparison with the non-rotatable arrangement, rotatable mounting of the guide sleeve provides the advantage of the guide sleeve being allowed to rotate jointly with the processing tool when the latter is driven rotationally. The internal diameter of the rotatably mounted guide sleeve may therefore be designed with narrower tolerances as compared with the non-rotatable arrangement, resulting in more accurate guidance of the processing tool. Due to the fact that the guide sleeve may rotate jointly with the rotationally driven processing tool, jamming of the processing tool due to chips being backed up in the guide sleeve or—for example in a case where a CFRP material is processed—chips being compacted in the guide sleeve is furthermore prevented from the outset.

1. An advancement guide unit for ensuring the straight-line motion of a manually guided machine tool in the direction of advancement thereof, comprising:
a support element to be supported on a workpiece being processed,
a carriage displaceably guided on the support element relative to the latter in the direction of advancement for supporting and guiding the machine tool,
a damper disposed between the support element and the carriage and acting in the direction of advancement, which dampens the initial stroke of the carriage toward the support element over a predetermined initial stroke distance (y).

2. The advancement guide unit according to claim 1, wherein the damper is disposed between the support element and the carriage so that dampening of the initial stroke of the carriage begins only after a first, undampened initial stroke of the carriage.

3. The advancement guide unit according to claim 1, wherein the damper is realized of a piston that is guided on a piston rod inside a cylinder filled with oil or gas.

4. The advancement guide unit according to claim 1, wherein the damper is arranged on the carriage in an axially adjustable manner for an adjustment of the length (y) of the undampened initial stroke thereof.

5. The advancement guide unit according to claim 1, wherein the support element may be applied against the workpiece being processed in the manner of a tripod having legs that are adjustable in length.

6. The advancement guide unit according to claim 1, wherein at least one guide element is arranged on the support element and guides the carriage in the direction of advancement.

7. The advancement guide unit according to claim 6, wherein a guide casing is provided on the support element and encompasses the carriage in the manner of a sleeve.

8. The advancement guide unit according to claim 6, wherein at least one guide column is disposed on the support element and received in an associated cylinder bore formed in the carriage.

9. The advancement guide unit according to claim 8, wherein the advancement guide unit comprises at least two guide columns disposed in pairs and diametrically relative to a longitudinal center axis of the advancement guide unit.

10. The advancement guide unit according to claim 6, wherein a piston guide means is disposed coaxially with a longitudinal center axis of the advancement guide unit, which piston guide means is realized of a piston on a piston rod arranged in the support element, and is received in a cylinder bore formed in the carriage.

11. The advancement guide unit according to claim 1, wherein a guide sleeve is disposed on the carriage, for receiving a processing tool rotationally driven by the machine tool.

12. The advancement guide unit according to claim 11, wherein the guide sleeve is arranged on the carriage in an axially displaceable manner.

13. The advancement guide unit according to claim 11, wherein the damper and the guide sleeve have a diametrical arrangement relative to a longitudinal center axis of the advancement guide unit.

14. The advancement guide unit according to claim 11, wherein the guide sleeve is arranged on the carriage non-rotatably relative to the latter.

15. The advancement guide unit according to claim 11, wherein the guide sleeve is mounted on the carriage rotatably relative to the latter.

16. The advancement guide unit according to claim 1, wherein an adjustable limit stop is provided on the support element or on the carriage for limiting the maximum initial stroke of the carriage relative to the support element.

17. The advancement guide unit according to claim 1, wherein a compression spring is disposed between the support element and the carriage, which exerts a return stroke force on the carriage.
